(19) United States
(12) Patent Application Publication
(10) Pub. No.: US 2024/0273664 A1
(43) Pub. Date: Aug. 15, 2024

(54) DISTRIBUTED SYSTEMS AND METHODS FOR PROCESSING INMATE POSTAL MAIL

(71) Applicant: HLFIP Holding, Inc., Largo, FL (US)

(72) Inventor: Jonathan D. Logan, Tampa, FL (US)

(21) Appl. No.: 18/440,827

(22) Filed: Feb. 13, 2024

Related U.S. Application Data
(60) Provisional application No. 63/445,136, filed on Feb. 13, 2023.

(51) Int. Cl. G06Q 50/60

(52) U.S. Cl. CPC G06Q 50/60

(57) ABSTRACT

The present disclosure is for a system and a method for processing mail intended for inmates of a correctional facility. Postal mail handling is managed so that it can be delivered in physical form when appropriate as dependent on each correctional facility's rules and regulations. In order to maintain the ability to deliver physical postal mail, the postal mail is associated with an identifier. Physical postal mail undergoes contraband analysis prior to physical delivery to ensure safety of correctional facility inmates and personnel. When contraband is detected, chain of custody information is logged so the physical mail can be handed over to authorities for appropriate action. Mail tracking, delivery, and receipt data may be logged for later retrieval and/or review.

### CROSS-REFERENCE TO RELATED APPLICATIONS

This application claims the benefit of U.S. Provisional Application No. 63/445,136, filed Feb. 13, 2023, titled “DISTRIBUTED SYSTEMS AND METHODS FOR PROCESSING INMATE POSTAL MAIL,” which is herein incorporated by reference in its entirety.

### BACKGROUND

### Field of the Art

The present invention relates to processing of postal mail for inmates or correctional facilities.

### Discussion of the State of the Art

Delivering physical mail to inmates is risky because of the possibility of handling and being exposed to drugs, dangerous substances, and other contraband. Preventing the delivery of drugs, dangerous substances, and other contraband to inmates is imperative for ensuring the safety of inmates, correctional facility personnel, and the correctional facility environment. One solution to this problem includes digitizing physical mail and providing inmates with the digital version of the mail thus eliminating physical mail delivery and thereby also eliminating the risk of physical contraband delivery. However, inmates desire physical mail for a variety of reasons (e.g. sentimental value of certain personal mail). Moreover, some groups may have sincere concerns with impacting an inmate's ability to handle physical mail items and the possibility of depriving an inmate of the sentimental or other value associated with their ability to handle and keep physical mail items.

Management of postal mail associated with correctional facilities in order to maintain the ability to deliver physical mail when appropriate poses many challenges. For one, different correctional facilities may have different rules surrounding delivery of physical mail. Some may have a strict, no physical mail delivery policy while others may be more lax and allow physical mail and others may fall somewhere in between allowing certain types of physical mail and/or allowing physical mail delivery at certain times (e.g. holiday cards). A mail processing facility may handle mail for a plurality of different correctional facilities and thus needs to manage the digitization of mail and corresponding handling of the physical mail as appropriate for each correctional facility. In some instances, the physical mail may be destroyed after digitization while in other instances, the physical mail may need to be stored (at least temporarily) to maintain the option of physical delivery at a later time should such be requested and/or appropriate. Furthermore, in most scenarios mail will undergo some type of contraband analysis prior to delivery to an inmate. When contraband is detected, it is important for the mail processing facility to handle the mail properly including, for example, recording the chain of custody information and preventing the destruction of the physical mail so that it can be turned over to the proper authorities. With all the variability in how physical mail is to be handled for different correctional facilities, there is a need for improved physical mail management systems and methods.

### SUMMARY

The present invention generally relates to novel distributed systems and methods for inmate communications and that improve inmate communications technology. More specifically, the systems and methods of the present invention are directed to novel arrangements of computer components configured into a distributed system that improves jail communications technology. These novel systems and methods provide technical improvements to jail and inmate communications technology unseen in the prior art and provide patent-eligible concepts under 35 U.S.C. § 101. By way of non-limiting example, embodiments like those disclosed in FIGS. 1-3 provide methods and systems involving networked and distributed computers, databases, kiosks and/or other terminals or stations specially configured into a distributed system that improves inmate communications technology. The disclosed and claimed improvements to inmate communications technology provide a specific distributed system that does not exist in the prior art. The disclosed and claimed improvements to inmate communication technology are patent-eligible under 35 U.S.C. § 101 and delineate the structure and function of distributed inmate communications systems and methods as shown by way of example in FIGS. 1-3. The disclosed and claimed improvements to inmate communications technology improve the performance and efficiency of content delivery to inmates while eliminating contraband. The network-distributed nature of embodiments of the present invention provides patent-eligible improvements to inmate communication technologies and services. The distributed systems and methods of the present invention, when considered as a whole, disclose patent-eligible subject matter under 35 U.S.C. § 101. The claims recited herein include several inventive concepts which when considered individually and as a whole provide specific improvements in inmate communications technology depending on the specific language of the subject claim. The claims recited herein thus integrate those inventive concepts into a patent-eligible distributed system and/or method for inmate communications that poses no risk of preemption under 35 U.S.C. § 101.

The present invention addresses the limitations described above by providing distributed systems and methods for processing physical postal mail. Through use of mail management software, coordination of mail digitization, contraband detection, and downstream routing of physical mail for storage and/or physical delivery can be accomplished across the distributed systems in an efficient and cost effective manner. The mail management software serves to manage information from, and coordinate the operations of, a number of distributed systems and/or facilities including mail processing (including digitization of physical mail), contraband detection, physical mail storage, and physical mail routing and delivery. In one aspect, mail management software coordinates physical mail processing such that physical mail can be associated with an identifier to be used in locating, routing and tracking of the physical mail during downstream routing. For example, an identifier generated by mail management software can be assigned to physical mail so that the physical mail can be identified and tracked as needed over time, such as when the physical mail is requested for delivery, allocated for contraband detection, allocated for storage (either short or long term), designated for destruction, and/or if chain of custody information is needed. Prior to any delivery of physical mail to an inmate, the mail management software is operable to ensure that the physical mail has previously been analyzed for contraband (including drugs or dangerous substances) and that the results of the contraband analysis satisfy necessary criteria. In one aspect, contraband analysis is only performed on mail designated for physical delivery thereby reducing costs as compared to performing contraband analysis on all processed mail. Mail which fails the contraband detection process may be flagged and stored until handed over to the appropriate authorities along with a chain of custody history which has been logged by the mail management software. Mail which is not immediately designated for physical delivery may be allocated to a storage location (short term or long term) until further action is deemed appropriate (e.g. destruction after a set period of time, physical delivery of the mail is requested, etc.).

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for managing the handling of mail for correctional facilities in accordance with an exemplary embodiment of the invention.

FIG. 2A illustrates a cloud-based software host in accordance with an exemplary embodiment of the present invention.

FIG. 2B illustrates a mail processing facility in accordance with an exemplary embodiment of the present invention.

FIG. 2C illustrates a contraband detection facility in accordance with an exemplary embodiment of the present invention.

FIG. 3 illustrates an exemplary process for managing the handling of mail for correctional facilities according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

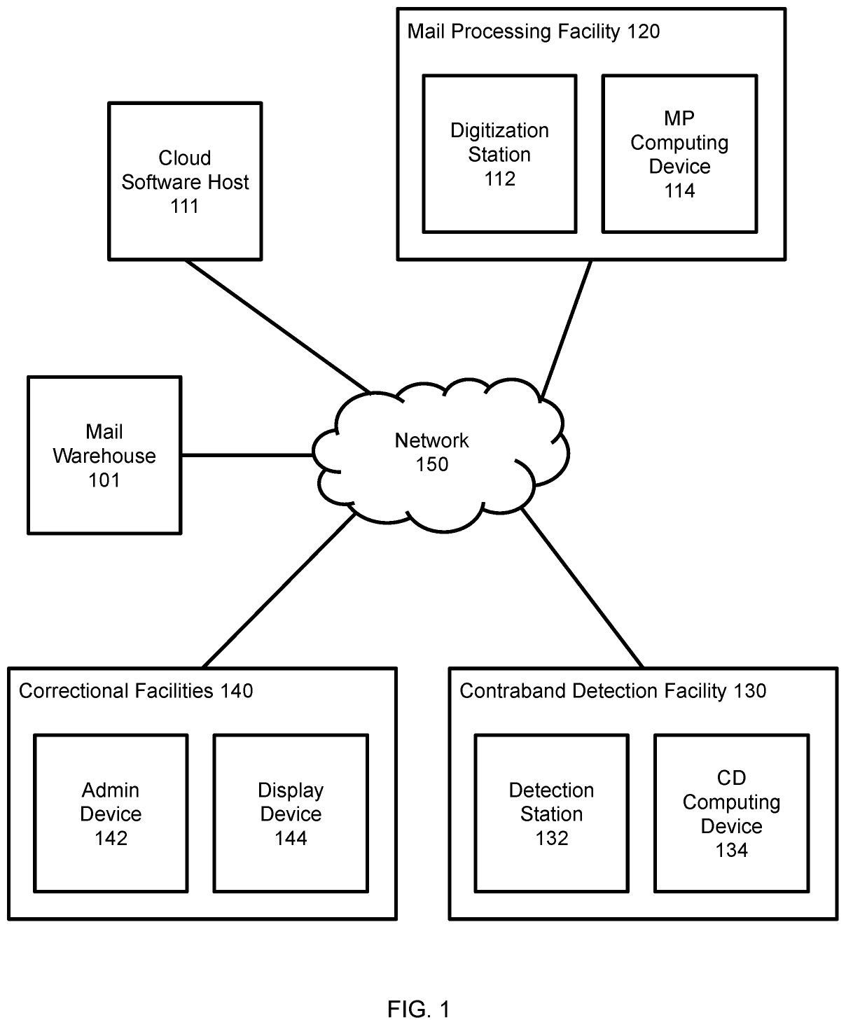

FIG. 1 illustrates an exemplary embodiment of a mail management system according to one embodiment. The system includes mail processing facility 120 (which comprises at least digitization station 112 and mail processing (MP) computing device 114), contraband detection facility 130 (which comprises at least detection station 132 and contraband detection (CD) computing device 134), correctional facility(ies) 140 (which comprise at least admin device 142 and display device 144), cloud software host 111, mail warehouse 101, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention. For example, although depicted as separate facilities connected by a network 150, the mail processing facility 120, contraband detection facility 130, and/or mail warehouse 101 may be combined in a single facility or location. Additionally, in another aspect one or more of these facilities may be adjacent to, part of, or located in correctional facility(ies) 140.

Mail processing facility 120 is operable to process physical mail having an intended recipient (e.g. inmate) associated with at least one correction facility. Mail processing facility 120 may receive physical mail intended for inmates associated with at least one correction facility. Mail processing facility 120 is operable to digitize the physical mail for delivery to inmates in an electronic format. Mail processing facility may comprise at least a digitization station 112 and mail processing (MP) computing device 114. Digitization station 112 is operable to generate a digital version of physical mail. Digitization station 112 may comprise a scanner, digital camera or similar device operable to convert physical mail into a digital format by generating a digital file comprising a digital copy of the contents of the physical mail. Mail processing (MP) computing device 114 generally comprises a computing device operable to at least one of process digitized mail and communicate with mail management software (e.g. cloud-based software host 111).

Contraband detection facility 130 is operable to process physical mail associated with at least one correctional facility to screen the physical mail for prohibited physical substances that may be hidden, soaked, or otherwise contained within the contents. Contraband detection facility 130 may perform at least one contraband detection and/or analysis process in order to determine if the physical mail is free from such substances such that it is suitable for delivery to an inmate at a correctional facility. Contraband detection facility 130 may comprise a detection station 132 operable to perform at least one of substance detection analysis and content detection analysis. Contraband detection facility 130 may comprise at least one contraband detection (CD) computing device 134 operable to communicate contraband detection data, analysis, and/or results to a mail management system such as cloud based software host 111. Although depicted here as a separate facility connected to a network 150, contraband detection facility may be incorporated into another facility, including at least one of mail processing facility, correctional facilities 140 and mail warehouse 101.

Correctional facilities 140 comprise at least one correctional facility housing inmates who are intended recipients of physical mail. Correctional facilities 140 may comprise at least one admin device 142 for use by correctional facility personnel in establishing and/or providing physical mail delivery instructions, such as indicating whether physical mail delivery is allowed, what types of physical mail are allowed, or individual requests for delivery of specific physical mail items, etc. Display device 144 may comprise at least one device operable to display digitized mail for an inmate such as tablet devices, kiosks devices, or other approved computerized devices suitable for displaying digitized mail.

Cloud software host 111 is operable to at least one of obtain mail information, coordinate mail handling, and provide mail information to at least one other facility and/or system. In one aspect, cloud software host 111 obtains digitized mail, obtains digital mail routing information, generates digital and/or physical mail identifiers, determines downstream routing, logs mail location information, logs mail forwarding information, and logs mail tracking and/or receipt data. In one aspect, determining downstream routing comprises determining routing based on at least one of correctional facility instructions, requests for physical mail delivery, and contraband detection results. In one aspect, cloud based software host allocates mail for at least one of storage, destruction, contraband analysis, delivery to the intended recipient (inmate) when the necessary criteria for delivery have been met (e.g. the mail has been deemed free of contraband and/or safe for delivery), or delivery to correctional facility 140 for storage by the facility, or delivery to a storage location as directed by correctional facility. In one aspect, cloud based software host only allocates mail for physical contraband analysis when necessary such as when physical mail delivery is requested by an inmate and/or when correctional facility policies/instructions allow for physical mail delivery, thereby reducing the necessary infrastructure and labor costs which would be associated with performing contraband analysis on every piece of physical mail. In one aspect, physical mail may be allocated for storage prior to any contraband analysis. In one aspect, physical mail may be allocated for storage after undergoing contraband analysis. In one aspect, physical mail may be allocated for storage for a duration spanning the inmate's sentence (or time in custody) such that upon release, the stored physical mail could be provided to the inmate.

Mail warehouse 101 is operable to store physical mail at least one of prior to and after processing of the mail at a mail processing facility 120 and prior to and after processing at a contraband detection facility 130. Mail warehouse 101 may store mail based on at least one of an identifier associated with the physical mail, processing status, and the correctional facility associated with the intended recipient. Although depicted here as a separate entity, mail warehouse 101 may be incorporated into another facility, including at least one of mail processing facility 120, correctional facilities 140, and contraband detection facility 130.

MP computing device 114, CD computing device 134, and admin device 142 may generally comprise user device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

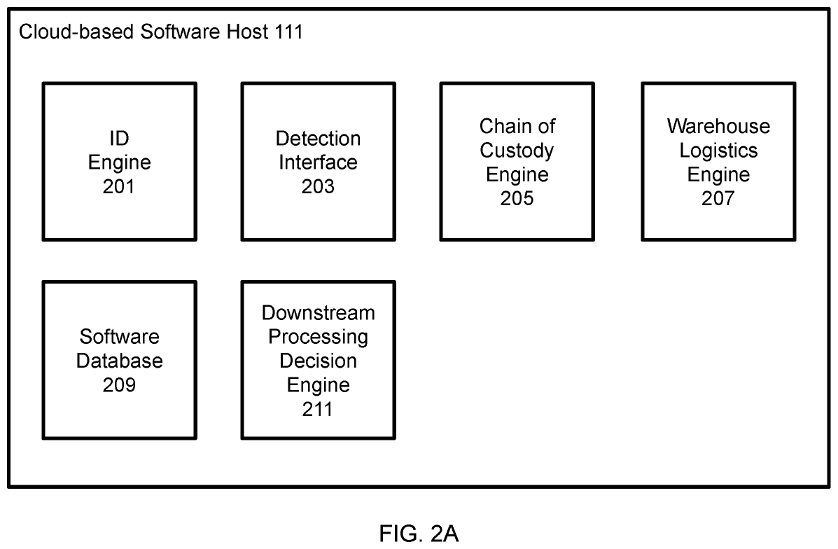

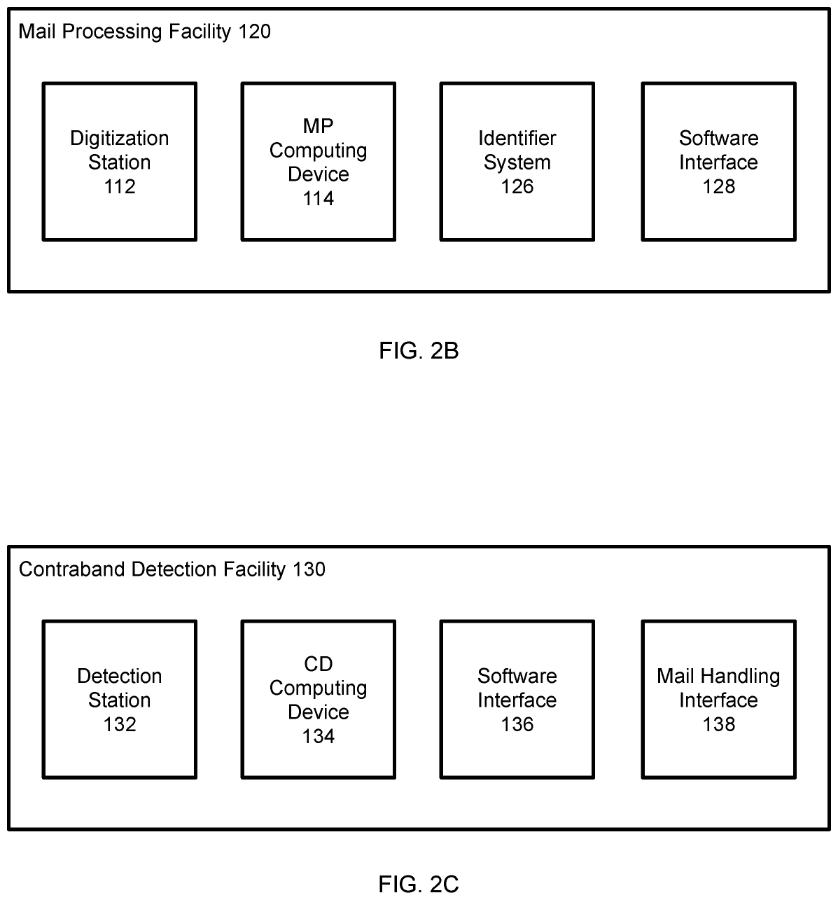

FIG. 2A illustrates an exemplary embodiment of the cloud-based software host 111. The cloud-based software host 111 includes identifier (ID) engine 201, detection interface 203, chain of custody engine 205, warehouse logistics engine 207, software database 209, and downstream processing decision engine 211. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Identifier (ID) engine 201 is operable to at least one of generate identifiers to be applied to digital and/or physical mail and obtain mail processing facility generated identifier information associated with digital and/or physical mail processing at a mail facility(ies). In one aspect, ID engine 201 communicates with at least one mail processing computing device to provide identifiers to be applied to at least one of physical mail being digitized and the resulting digitized mail. In one aspect, ID engine 201 generates a unique identifier for each item of physical mail. In one aspect, the ID engine 201 generates at least one identifier based on information obtained from the MP computing device, such as the intended recipient (e.g. an inmate) of the mail being processed, the sender of the mail being processed, or the type of mail being processed (e.g., greeting card, handwritten letter, typed letter, publication, or the like).

Downstream processing decision engine 211 is operable to determine downstream processing of physical mail. In one aspect, as a batch or piece of physical mail is processed at a mail processing facility, such as mail processing facility 120, downstream processing decision engine 211 determines if and what downstream processing is necessary for the corresponding physical mail. In one aspect, downstream processing may comprise at least one of allocating physical mail for short or long term storage, allocating physical mail for destruction, allocating physical mail for contraband detection, allocating mail for delivery to authorities, and allocating physical mail for delivery to the intended recipient. In one aspect, downstream processing decision engine 211 determines downstream processing based on instructions or criteria received, for example, based on mail type, mail recipient, correctional facility housing the recipient, individual requests for physical delivery of specific mail items, or similar. Downstream processing may change over time. For example, changes in correctional facility policies over time, later requests for routing of physical mail to inmates (e.g. upon a later request from an inmate), etc., may trigger updates to the downstream processing. Updates to downstream processing decisions may result in updated routing instructions such as allocating physical mail for retrieval from storage for delivery to an inmate (after first being routed through contraband detection if necessary or not previously completed).

Detection interface 203 is operable to communicate with at least one contraband detection system associated with contraband detection analysis of physical mail. Detection interface 203 may communicate with at least one contraband detection facility, such as contraband detection facility 130. Detection interface 203 may obtain contraband detection results for use by downstream processing decision engine 211 in determining whether mail is suitable for delivery to an inmate or should be provided to appropriate authorities.

Chain of custody engine 205 is operable to record the chain of custody of each piece of physical mail throughout mail processing. Chain of custody engine 205 is operable to record at least one of sender of the physical mail, intended recipient of the physical mail, contraband detection results, mail processing personnel involved in handling of the physical mail, and physical mail location and/or routing history. Chain of custody engine 205 may be operable to generate and/or provide a report of physical mail processing history, in particular when contraband detection analysis indicates the presence of contraband in the physical mail.

Warehouse logistics engine 207 is operable to manage warehouse storage information associated with physical mail. In one aspect, warehouse logistics engine 207 is operable to allocate physical mail for storage in at least one warehouse. In one aspect, warehouse logistics engine 207 allocates physical mail for storage based on at least one of date of physical mail processing, location of intended recipient of physical mail, physical mail type, destination facility (e.g. facility instructions), and information obtained from downstream processing decision engine 211. In one aspect, warehouse logistics engine 207 is operable to identify physical mail location upon a request for delivery of the physical mail (e.g. upon request from the intended recipient, such as an inmate, for delivery of the physical mail).

Software database 209 is operable to store information associated with mail processing and management. Software database 209 may store at least one of digitized mail file(s), digital mail routing data, digital and/or physical mail identifiers, correctional facilities instructions, downstream routing information, storage information (e.g. location), destruction information, contraband detection information (e.g. flags), chain of custody information, mail forwarding data, and mail tracking and receipt data.

FIG. 2B illustrates an exemplary embodiment of the mail processing facility 120. The mail processing facility 120 includes digitization station 112, mail processing (MP) computing device 114, identifier system 126, and software interface 128. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Digitization station 112 is operable to generate a digital version of physical mail. Digitization station 112 may comprise a scanner, digital camera or similar device operable to convert physical mail into a digital format by generating a digital file comprising a digital copy of the contents of the physical mail.

Mail processing (MP) computing device 114 generally comprises a computing device operable to at least one of process digitized mail and communicate with mail management software (e.g. cloud-based software host 111). In one aspect, MP computing device 114 is operable to obtain digitized mail and apply an identifier to the digitized mail. In one aspect, applying the identifier to the digitized mail comprises embedding and/or digitally printing the identifier on the digitized mail. In another aspect, the identifier applied to the digitized mail comprises embedding a visible or invisible watermark and/or embedded metadata. In one aspect, MP computing device 114 is operable to obtain and/or generate mail routing information for at least one of the digitized mail and corresponding physical mail. In one aspect, MP computing device 114 obtains the identifier from external software, such as cloud based software host 111 for use in applying the identifier to digitized mail.

Identifier system 126 is operable to at least one of obtain and generate identifiers to be applied to physical mail. In one aspect, identifier system 126 is operable to print physical identifiers directly on physical mail. In one aspect, identifier system 126 is operable to print an identifier to be attached to physical mail such as a label, sticker, etc. In one aspect, identifier system 126 applies the same identifier to the physical mail as that applied by the MP computing device to the digitized mail. In one aspect, identifier system 126 obtains an identifier from external software, such as cloud based software host 111 for use in applying the identifier to physical mail.

Software interface 128 is operable to communicate with external software associated with mail management, such as cloud based software host 111. Software interface 128 may be operable to at least one of provide digitized mail, provide mail routing information, obtain mail routing information, provide identifier information generated at mail processing facility in association with digitizing mail, obtain identifier information from cloud-based software host for application to digitized and/or physical mail, etc.

FIG. 2C illustrates an exemplary embodiment of the contraband detection (CD) facility 130. The contraband detection facility 130 includes detection station 132, CD computing device 134, software interface 136, and mail handling interface 138. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Detection station 132 generally comprises at least one contraband detection sensor, device, component, and/or system. Detection station 132 may be operable to perform at least one of substance detection analysis and content detection analysis. Detection station 132 may comprise at least one of non-destructive and semi-destructive detection approaches. Detection station 132 may comprise at least one of particle detection based approaches and chemical analysis based approaches. In one aspect, detection station 132 may be incorporated into a mail processing facility, such as being incorporated into digitization station such that digitization and contraband detection analysis can be performed simultaneously.

Contraband detection (CD) computing device 134 generally comprises a computing device operable to at least one of obtain detection analysis data and/or results, and communicate with mail management software (e.g. cloud-based software host 111). In one aspect, CD computing device 134 obtains detection analysis data and/or results and associates the corresponding mail with the detection results. In one aspect, CD computing device 134 may associate mail with a flag or other indicator indicating the results of the detection analysis. In one aspect, CD computing device 134 may flag only mail which fails the contraband detection analysis. In one aspect, CD computing device 134 may flag all mail with an indicator based on the detection results, such as a pass or fail flag/indicator. In one aspect, CD computing device 134 may generate and/or process mail routing based on the results of the contraband detection. For example, in one aspect, CD computing device 134 may receive routing instructions from cloud based software host based on the contraband detection analysis such that the physical mail can be appropriately routed, such as being routed for delivery to an inmate when physical mail passes the contraband analysis and routed for delivery to the authorities when physical mail fails the contraband analysis.

Software interface 136 is operable to communicate with external software associated with mail management, such as cloud based software host 111. Software interface 136 may be operable to at least one of provide detection analysis data and/or results, provide identifier information for the analyzed mail, provide mail routing information, and obtain mail routing information.

Mail handling interface 138 is operable to obtain mail handling information. Mail handling information may be obtained in association with mail routing from the contraband detection facility after detection analysis processing. Mail handling information may comprise at least one of mail tracking information, mail carrier information, mail pickup information, and mail delivery information for mail coming to and leaving the contraband detection facility.

Although depicted as separate facilities, the mail processing facility of FIG. 2B and contraband detection facility of FIG. 2C may be combined in a single facility. In addition, a plurality of such facilities at different locations may be employed without departing from the scope of the invention.

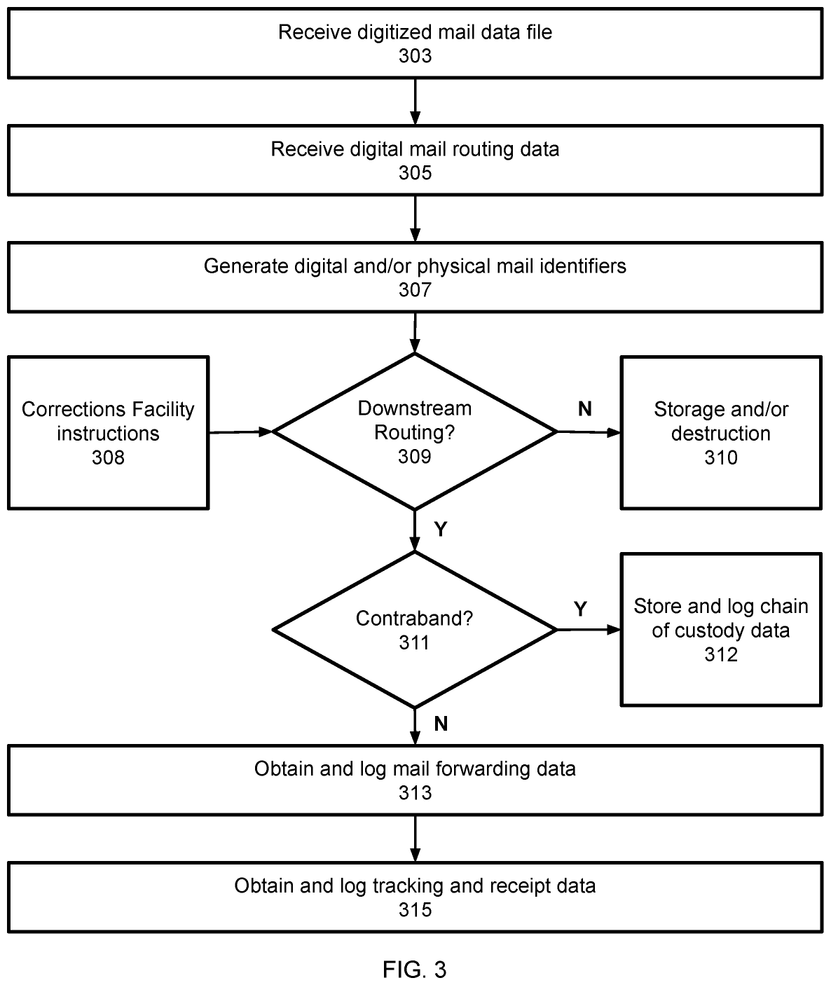

FIG. 3 illustrates an exemplary process for managing information associated with the handling of mail associated with a correctional facility according to one embodiment of the invention. The process comprises receiving digitized mail file 303, receiving digital mail routing data 305, generating digital and/or physical mail identifiers 307, obtaining correctional facility instructions 308, determining downstream routing 309, assigning the mail for storage and/or destruction 310, contraband analysis 311, storing and logging chain of custody data 312, obtaining and logging mail forwarding data 313, and obtaining and logging mail tracking and receipt data 315. The process may comprise additional steps, fewer steps, and/or a different order of steps without departing from the scope of the invention as would be apparent to one of ordinary skill in the art.

At step 303, the process comprises receiving at least one digitized mail file. The digitized mail file(s) may be received by the cloud based software host. In one aspect, the digitized mail file may be received in at least one of a PDF format, PNG format, JPEG format, GIF format, or the like. The digitized mail file(s) may be received from a mail processing facility (e.g. mail processing facility 120 described above). In one aspect, each received digitized mail file may be associated with at least one of an identifier for identifying and managing the handling of the digital file. In one aspect, the identifier may be associated with the digitized mail file upon digitization at a mail processing facility prior to being received by the cloud based software host. In one aspect, the received digitized mail file comprises the identifier embedded in the file (e.g. digitally printed on the digitized version of the mail).

At step 305, the process may comprise receiving digital mail routing data. Digital mail routing data may comprise at least one of an intended recipient (and/or an intended recipient identifier), a target facility (and/or target facility identifier) to which the digital mail should be routed, and a timestamp associated with the date (and optionally time) which the digital mail was sent to the intended destination. For example, digital mail routing data may comprise an inmate identifier and/or correctional facility where the digital mail is to be sent.

At step 307, the process may comprise at least one of generating and applying digital and/or physical mail identifiers. Each digitized mail file may be associated with at least one identifier indicating at least one of the intended recipient of the digitized mail file (e.g. an individual in a correctional facility), the physical mail with which the digital mail is associated, a physical mail type (e.g. card, letter, etc.), the sender of the physical mail, etc. Similarly, each piece of physical mail may be associated with at least one identifier indicating at least one of the intended recipient of the physical mail (e.g. an individual in a correctional facility), the digital mail with which the physical mail is associated, downstream routing of the physical mail, the sender of the physical mail, etc. As an alternative to the identifier being applied to the digitized mail in step 302, the digital mail file may be received without an identifier which is then generated and/or applied in step 307 of the process.

At step 308, the process may comprise obtaining correctional facility instructions. In one aspect, each correctional facility may have their own instructions for handling of physical mail. For example, a given correctional facility may have universal rules regarding physical mail (e.g. never deliver, always deliver, conditional delivery, etc.), case by case rules (e.g. some criteria must be met, physical delivery must be approved, etc.), periodic rules (e.g. seasonal rules for holiday cards), mail type rules (e.g. only mail of certain physical types is allowed), etc. In one aspect, obtaining correctional facility instructions comprises obtaining instructions from a database of stored correctional facilities instructions. In one aspect, obtaining correctional facility instructions comprises obtaining instructions from a correctional facility, such as on a case by case basis for each piece of mail, for a batch of mail being processed, at periodic intervals, etc.

At step 309, the process may comprise determining downstream routing of physical mail. Downstream routing may be based on at least one of correctional facility instructions and intended recipient request information for physical mail delivery. In one aspect, the downstream routing may be determined in substantially real-time as mail is digitized. In one aspect, downstream routing conditions may change over time as a result of intended recipient requests for physical mail. For example, initial processing of mail (including digitizing and routing) may comprise providing the intended recipient (e.g. inmate) with an option to receive the mail in physical form (when such is authorized by the correctional facility). When the intended recipient elects for physical delivery, the downstream routing may be adjusted for such as part of the initial processing to allocate the physical mail for the necessary processing for physical delivery. When the intended recipient declines physical delivery, the downstream routing may be adjust for such by allocating the physical mail for storage and/or destruction. In one aspect, the inmate may make a request for physical delivery of mail at a later date after the initial processing in which case the downstream routing may be adjusted to indicate the physical mail should be obtained from storage and allocated for physical delivery.

At step 310, the process may comprise assigning the mail for storage and/or destruction. Based on at least one of correctional facility instructions and intended recipient request information, physical mail may be allocated for storage and/or destruction. For example, when correctional facility instructions do not allow for delivery of physical mail, the mail may be allocated for destruction and/or temporary storage prior to destruction. When correctional facility instructions do allow for physical mail delivery, but physical delivery has not been elected or requested by the intended recipient, the physical mail may be allocated for storage (e.g. short-term, long-term, permanent) so that should the physical mail be needed at a later time (e.g. due to a physical mail request), the mail can be retrieved from storage.

At step 311, the process may comprise contraband analysis. When downstream routing at step 309 indicates that physical mail should be routed for delivery to the intended recipient, the physical mail may undergo contraband analysis to determine suitability for physical delivery. Although depicted here as occurring when downstream routing to the intended recipient is affirmed, contraband analysis may be performed in other scenarios as well, such as prior to designating the physical mail for storage, at any other point in the mail processing timeline, and/or regardless of correctional facility instructions related to delivery of physical mail. In one aspect, all mail may undergo contraband analysis as part of the intake processing in which case rather than repeating contraband analysis at this step, the results of a previously conducted contraband analysis can be imported or otherwise used in determining subsequent mail handling. In one aspect, contraband analysis may comprise passing the physical mail through at least one contraband detector or contraband detection process. When the results of the contraband analysis indicate the presence of contraband, the physical mail may be prevented from physical delivery and instead diverted to storage and/or delivery to the appropriate authorities as described in step 312. When the results of the contraband analysis indicate no contraband detected, the process may continue to step 313 to further process the mail prior to physical delivery.

At step 312, the process may comprise storing and logging chain of custody data. When contraband is detected, the process may comprise logging chain of custody data or other information governing authorities are interested in or require, such as the sender of the physical mail and/or the intended recipient. In addition, the actual physical mail may undergo a secure storage process until a time when the mail can be placed in the custody of the appropriate authorities.

At step 313, the process may comprise obtaining and logging mail forwarding data. When contraband analysis results in no indication of contraband, the physical mail may be approved for forwarding to the intended recipient and/or facility in which case the process may comprise obtaining and logging the relevant mail forwarding data. In one aspect, the forwarding data obtained and logged comprises at least one of the intended recipient, an intended recipient identifier, a facility and/or facility identifier associated with the intended recipient, physical mail delivery instructions associated with the facility, current location of they physical mail, mode of delivery/transportation from current location to target facility, an intended physical mail delivery date, etc.

At step 315, the process may comprise obtaining and logging mail tracking and receipt data. Mail tracking and receipt data may comprise at least one of a scheduled mail pickup location, date, and/or time, actual mail pickup location, date, and/or time, mail carrier or mode of delivery/transportation, scheduled mail delivery location, date, and/or time, actual mail delivery location, date, and/or time, receipt confirmation (e.g. a signature), etc. The obtained mail tracking and receipt data may be stored in a database for later retrieval as needed.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

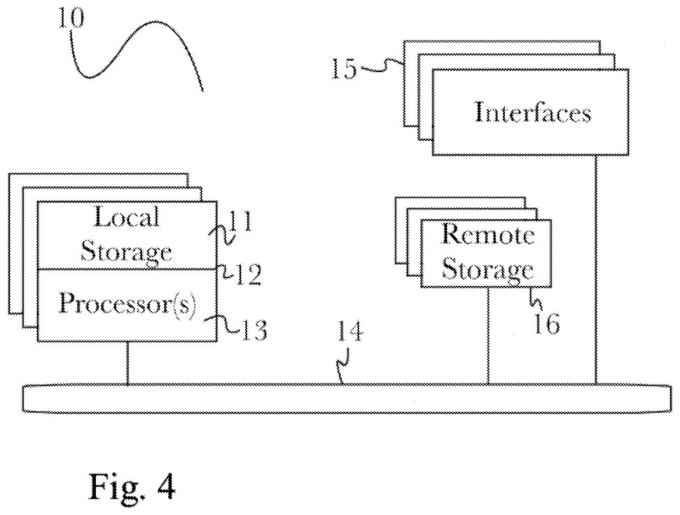

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, interfaces or the like may be and/or comprise hardware and/or software as described herein. For example, the cloud software host 111, mail processing facility 120, contraband detection facility 130, correctional facilities 140, and mail warehouse 101, including any subcomponents of any of these, may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information. Additionally, interfaces may comprise hardware-hardware interfaces, hardware-software interfaces, software-software interfaces, human-hardware interfaces, and/or human-software interfaces.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

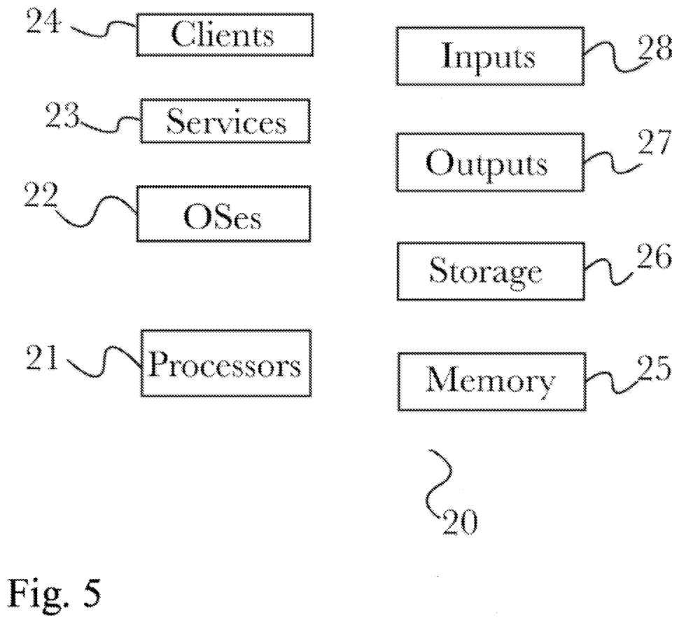

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

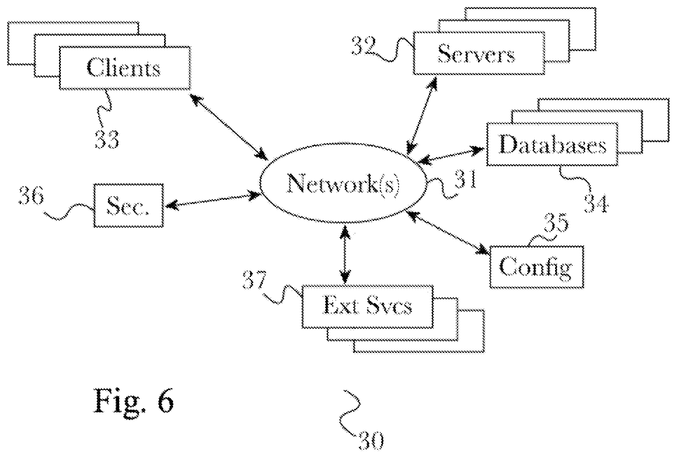

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

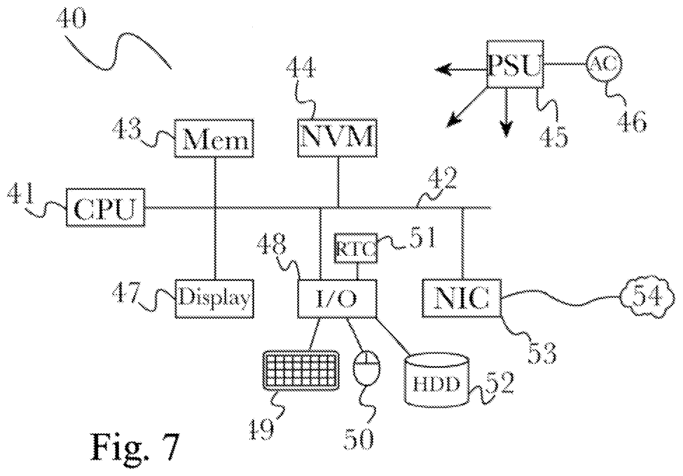

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for processing and managing physical postal mail for inmates of a correctional facility, the computer implemented method comprising:
receiving a digitized mail file, the mail file comprising a digital representation of physical postal mail sent to an inmate of a correctional facility, the mail file generated by digitizing the postal mail at a mail processing facility;
receiving digital mail routing data, the routing data comprising instructions associated with at least one of delivery and storage of at least one of the digitized mail file and the associated physical postal mail;
generating at least one mail identifier, the mail identifier comprising at least one of a digital identifier and a physical identifier, the at least one mail identifier operable to be attached to the digitized mail and/or the physical postal mail;
obtaining correctional facility instructions, the correctional facility instructions indicating at least one of restrictions and requirements associated with the delivery of physical mail to an inmate of the correctional facility;
determining downstream routing instructions, the downstream routing instructions comprising an indication that the physical mail associated with the digitized mail file should be allocated for at least one of physical delivery to the inmate, storage, and destruction;
receiving contraband analysis results data for mail allocated for physical delivery to the inmate, the contraband analysis results data providing an indication that the physical mail is free of contraband or contains contraband;
storing and logging chain of custody data for mail identified as containing contraband;
obtaining and logging mail forwarding data, the mail forwarding data comprising information associated with the physical delivery of the postal mail; and
obtaining and logging mail tracking and receipt data, the mail tracking and receipt data comprising information associated with the delivery of the physical mail to the intended inmate and/or facility.

2. The computer implemented method according to claim 1, the digital mail file comprising at least one of a PDF format, PNG format, JPEG format, GIF format.

3. The computer implemented method according to claim 1, the digital mail routing data comprising at least one of an intended recipient, an intended recipient identifier, a target facility, a target facility identifier, and a timestamp indicating when the digital mail was sent to the intended destination.

4. The computer implemented method according to claim 1, wherein the identifier indicates at least one of an intended recipient of the digitized mail file, the physical mail with which the digital mail is associated, a physical mail type, and the sender of the physical mail.

5. The computer implemented method according to claim 1, wherein the identifier indicates at least one of an intended recipient of the physical mail, the digital mail with which the physical mail is associated, downstream routing of the physical mail, and the sender of the physical mail.

6. The computer implemented method according to claim 1, the correctional facility instructions comprising an indication that physical mail delivery is acceptable or physical mail delivery is not acceptable, that physical mail delivery.

7. The computer implemented method according to claim 6, wherein an indication that physical mail delivery is acceptable comprises an indication that the physical mail must meet certain criteria, wherein the criteria comprise at least one of a defined mail type and the physical mail is free of contraband.

8. The computer implemented method according to claim 6, wherein the correctional facility instructions are obtained from a database of stored correctional facility instructions.

9. The computer implemented method according to claim 1, wherein the downstream routing is determined based on at least one of the correctional facility instructions and a mail type associated with the physical mail.

10. The computer implemented method according to claim 1, wherein the downstream routing is determined based on a request by the recipient to receive the physical mail in physical form.

11. The computer implemented method according to claim 1, wherein the downstream routing is at least one of determined or updated based on the contraband analysis results data.

12. The computer implemented method according to claim 11, wherein the downstream routing comprising allocating the physical mail for delivery to an appropriate authority based on the contraband analysis results data.

13. The computer implemented method according to claim 1, wherein chain of custody data is stored and logged based on the contraband analysis results data.

14. The computer implemented method according to claim 1, the mail forwarding data comprising at least one of an intended recipient, an intended recipient identifier, a facility name, facility address and/or facility identifier associated with the intended recipient, physical mail delivery instructions associated with a facility, current location of the physical mail, mode of delivery and/or transportation of the physical from a current location to a target facility, and an intended physical mail delivery date.

15. The computer implemented method according to claim 1, the mail tracking and receipt data comprising at least one of a scheduled mail pickup location, date, and/or time, actual mail pickup location, date, and/or time, mail carrier, mode of delivery and/or transportation, scheduled mail delivery location, date, and/or time, actual mail delivery location, date, and/or time, receipt confirmation

16. A computing system for processing and managing physical postal mail for inmates of a correctional facility, the computing system comprising:
at least one computing processor; and
memory comprising instructions that, when executed by the at least one computing processor, enable the computing system to:
receive a digitized mail file, the mail file comprising a digital representation of physical postal mail sent to an inmate of a correctional facility, the mail file generated by digitizing the postal mail at a mail processing facility;
receive digital mail routing data, the routing data comprising instructions associated with at least one of delivery and storage of at least one of the digitized mail file and the associated physical postal mail;
generate at least one mail identifier, the mail identifier comprising at least one of a digital identifier and a physical identifier, the at least one mail identifier operable to be attached to the digitized mail and/or the physical postal mail;
obtain correctional facility instructions, the correctional facility instructions indicating at least one of restrictions and requirements associated with the delivery of physical mail to an inmate of the correctional facility;
determine downstream routing instructions, the downstream routing instructions comprising an indication that the physical mail associated with the digitized mail file should be allocated for at least one of physical delivery to the inmate, storage, and destruction;
receive contraband analysis results data for mail allocated for physical delivery to the inmate, the contraband analysis results data providing an indication that the physical mail is free of contraband or contains contraband;
store and log chain of custody data for mail identified as containing contraband;
obtain and log mail forwarding data, the mail forwarding data comprising information associated with the physical delivery of the postal mail; and
obtain and log mail tracking and receipt data, the mail tracking and receipt data comprising information associated with the delivery of the physical mail to the intended inmate and/or facility.

17. A non-transitory computer readable medium comprising instructions that when executed by a processor enable the processor to execute a computer implemented method, the method comprising:
receiving a digitized mail file, the mail file comprising a digital representation of physical postal mail sent to an inmate of a correctional facility, the mail file generated by digitizing the postal mail at a mail processing facility;
receiving digital mail routing data, the routing data comprising instructions associated with at least one of delivery and storage of at least one of the digitized mail file and the associated physical postal mail;
generating at least one mail identifier, the mail identifier comprising at least one of a digital identifier and a physical identifier, the at least one mail identifier operable to be attached to the digitized mail and/or the physical postal mail;
obtaining correctional facility instructions, the correctional facility instructions indicating at least one of restrictions and requirements associated with the delivery of physical mail to an inmate of the correctional facility;
determining downstream routing instructions, the downstream routing instructions comprising an indication that the physical mail associated with the digitized mail file should be allocated for at least one of physical delivery to the inmate, storage, and destruction;
receiving contraband analysis results data for mail allocated for physical delivery to the inmate, the contraband analysis results data providing an indication that the physical mail is free of contraband or contains contraband;
storing and logging chain of custody data for mail identified as containing contraband;
obtaining and logging mail forwarding data, the mail forwarding data comprising information associated with the physical delivery of the postal mail; and
obtaining and logging mail tracking and receipt data, the mail tracking and receipt data comprising information associated with the delivery of the physical mail to the intended inmate and/or facility.
